(19) United States
(12) Patent Application Publication
(10) Pub. No.: US 2009/0307155 A1
(43) Pub. Date: Dec. 10, 2009

(54) FRANKING SYSTEM MAKING IT POSSIBLE TO PROCESS MAILPIECES HAVING DIFFERENT DESTINATIONS

(75) Inventor: Ruben Rico, Paris (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST TECHNOLOGIES, Bagneux (FR)

(21) Appl. No.: 12/481,176

(22) Filed: Jun. 9, 2009

(30) Foreign Application Priority Data
Jun. 10, 2008 (FR) 0853831

(51) Int. Cl. G07B 17/02; G06Q 50/00

(52) U.S. Cl. 705/404

(57) ABSTRACT

A method of searching for a destination price zone applicable to a mailpiece, the method consisting in scanning the mailpiece so as to obtain an image of the destination address, in extracting an item of destination data from said image, in comparing the destination data extracted in this way with destination price zones previously stored in a database, in preventing any printing of a postal imprint by the franking means of the franking machine if said destination data does not belong to any of the destination price zones in said database or if such belonging cannot be established before the mailpiece goes past said franking means, and in incrementing a counter totaling a number of non-franked mailpieces that is associated with at least one determined reason for non-franking.

### TECHNICAL FIELD

The present invention relates to the field of mail handling, and relates more particularly to a method of searching for the price zone that is applicable to a mailpiece as a function of its destination and optionally of the postal services requested.

### PRIOR ART

The franking amount, i.e. the amount of the postage, for a mailpiece depends on various parameters such as its mail class, its weight and/or size, and its destination price zone, and more particularly its post code or ZIP code, and the chosen postal service (tracked mail, registered or certified mail, recorded-delivery or return-receipt mail) when such a chosen service exists. On the most recent franking machines or “postage meters”, the weights and/or the sizes of the mailpieces are obtained automatically by mechanical or optical sensors disposed in the feeder of the machine or in the machine itself, along the transport path along which the mailpiece is conveyed. Conversely, the mail class and the destination price zone are still input manually by the operator at the user interface of the franking machine, as is the chosen postal service. Such inputting is not disadvantageous per se when the mailpieces are processed in batches, in which case the batches are made up on the basis of mail class and of destination price zone, thereby enabling the operating to perform a single information input operation prior to processing an entire batch. However, such processing in batches, and in particular sorting by destination price zone (sorting by class is very simple because there are, at the most, two or three classes, and will continue to require prior selection of the appropriate class), requires lengthy and therefore costly preparation. If such sorting into batches is not performed, i.e. if batches that are non-uniform in terms of destination price zone are processed, such inputting is very disadvantageous for the franking throughput rate, because the operator must then be continually stopping the machine in order to input the destination price zone that is appropriate for the mailpiece being processed.

A need therefore currently exists for a franking machine that makes it possible to process “mixed mail”, i.e. batches that are non-uniform in terms of destination price zone and/or of postal service, without having to stop the machine, so as to make it possible to achieve high mail processing rates (typically 150 envelopes per minute). The franking machine should also, without necessarily using an additional transport path with which a reject tray is conventionally associated, be capable of processing mailpieces that are not recognized or that have incorrect addresses, i.e. mailpieces that are Undeliverable-As-Addressed (UAA).

### OBJECTS AND DEFINITION OF THE INVENTION

An object of the present invention is thus to provide a method of searching for destination price zones in a mailpiece franking machine that makes it possible to process batches of mailpieces that are not uniform in terms of destination price zones and of postal service without having to stop the machine. An object of the invention is to guarantee such processing without implementing complex equipment other than that existing in current franking systems.

These objects are achieved by a method of searching for a destination price zone applicable to a mailpiece fed into a franking machine of the closed type having means for franking it with a postal imprint, and ejected towards a mailpiece-receiving tray once it is franked, wherein, for each of said mailpieces, said method comprises the following steps:
scanning said mailpiece so as to obtain an image of at least a destination address printed on said mailpiece;
extracting an item of destination data from said image by means of an optical character recognition unit;
comparing said destination data extracted from said image of the destination address of said mailpiece with destination price zones previously stored in a database so as to determine whether said extracted destination data belongs to any of said destination price zones stored in said database;
if it cannot be established that said extracted destination data belongs to any of said destination price zones stored in said database before the mailpiece goes past said franking means, incrementing a counter totaling a number of non-franked mailpieces that is associated with at least one determined reason for non-franking; and
ejecting said mailpiece, without printing said postal imprint, and without stopping conveying of the following mailpieces through said franking system.

Thus, with the present invention, the process of conveying mailpieces is not interrupted, and the printing rate is thus not reduced when the destination price zone (in practice the post code or the ZIP code) cannot be recognized. In addition, suspending the printing in the event of non-recognition or of late recognition makes it possible to avoid financial losses resulting from printing a postal imprint on a mailpiece whose destination is erroneous or cannot be determined in time.

Provision may be made for an additional step of printing a specific marking on each of said mailpieces for which it has not been possible to find said destination data in said database, or for a step of printing a serial number on each of said mailpieces.

Advantageously, said at least one determined reason for non-franking is at least one of the following reasons: processing incomplete, characters illegible or incomplete, recipient unknown at the address indicated, or address inexistent.

Preferably, the method of the invention further comprises a step of reloading said non-franked mailpieces followed by a step of manually searching for a valid destination price zone on the user interface of said franking system.

Advantageously, said non-franked mailpieces are directed towards a reject tray.

Said specific marking preferably comprises a bar code or an identification number.

Preferably, the method of the invention further comprises a step of extracting an item of service data from said image by means of said optical character recognition unit so as to determine a characteristic code of the service in question, and an associated tracking number, if it can be established that said extracted destination data belongs to at least one of said destination price zones stored in said database.

It may further comprise a step of automatically filling in a form relating to the recognized service with a recipient name, a post code, and said tracking number, and a step of transmitting said form to a remote server.

The present invention also provides a franking machine of the closed type making it possible to search for the destination price zone that is applicable to a mailpiece fed into said machine and ejected towards a mailpiece-receiving tray once it is franked, wherein said franking machine includes:
means for scanning said mailpiece and for obtaining an image of at least a destination address printed on said mailpiece;
means for extracting an item of destination data from said image by means of an optical character recognition unit;
means for comparing said destination data extracted from said image of the destination address of said mailpiece with destination price zones previously stored in a database, and for determining whether said extracted destination data belongs to any of said destination price zones stored in said database;
means for preventing printing of a postal imprint while the mailpiece is going past franking means of said franking machine of the closed type if it cannot be established that said extracted destination data belongs to any of said destination price zones stored in said database before the mailpiece goes past said franking means; and
means for incrementing a counter totaling a number of non-franked mailpieces that is associated with at least one determined reason for non-franking.

Preferably, said machine further includes means for printing a specific marking on each of said mailpieces for which it has not been possible to find said destination data in said database, or means for printing a serial number on each of said mailpieces. It can also include a reject tray towards which said non-franked mailpieces are directed.

Preferably, said specific marking comprises a bar code or an identification number.

### BRIEF DESCRIPTION OF THE DRAWINGS

Other characteristics and advantages of the present invention appear more clearly from the following description, given by way of non-limiting indication, and with reference to the accompanying drawings, in which:

FIG. 1 is a view of a franking machine of the closed type implementing a method of the invention for searching for destination price zones; and

FIG. 2 is a flow chart explaining how the FIG. 1 method of franking mailpieces operates.

### DETAILED DESCRIPTION OF A PREFERRED IMPLEMENTATION

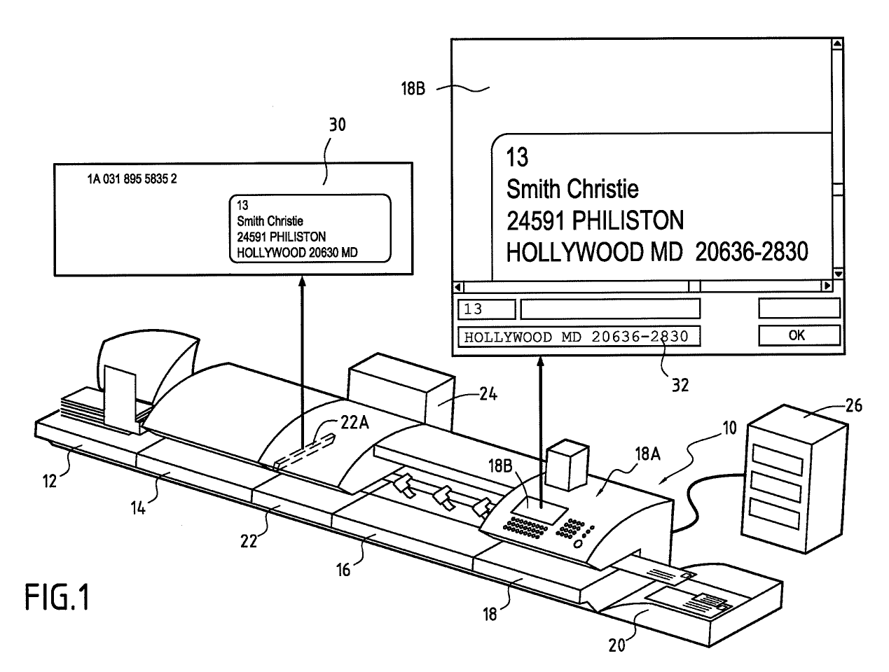

FIG. 1 is a diagrammatic view of a franking machine of the closed type of the invention that makes it possible to search for destination price zones applicable to a batch of mailpieces having destinations that are different from one another, and to process mailpieces that have incorrect destination addresses (UAA mailpieces).

Conventionally, a mailpiece franking machine 10 of the closed type comprises, as is known and disposed from upstream to downstream in the direction of advance of the mailpieces: a mailpiece feed module 12 designed to receive a stack of mailpieces that are typically of the mixed type (i.e. of different sizes and weights), and each of which bears a destination address; optionally a selector and conveyor module 14 for selecting the mailpieces and conveying them one-by-one when the feed module does not perform such individual selection directly; preferably a dynamic weigh module 16 for determining the weight and optionally the size of each selected mailpiece; a franking module 18 designed to print a postal imprint on each of the mailpieces selected one-by-one and weighed in this way; and a mailpiece-receiving tray 20 for receiving the franked mailpieces. The franking module also has an improved user interface 18A that makes it possible, in particular, to select the class of mail and that can incorporate a screen 18B of the touch-sensitive type. Preferably, and also as is known, said franking module is connected to a remote server 26 of a dealer of the franking machine, which machine is also connected to a server (not shown) of a postal authority or of a private carrier who delivers the mail.

In accordance with the invention, the franking machine of the closed type further comprises an independent optical read module 22 having an advantageously linear sensor 22A of the “contact” type, preferably disposed upstream from the dynamic weigh module 16 for the purposes of acquiring a digital image of all or some of the mailpiece and, in association with Optical Character Recognition (OCR) software, of extracting from said image at least one item of destination address data and/or at least one item of service data borne by the mailpiece. The franking machine also has storage means of the database type 24 making it possible to verify the destination addresses (and to verify whether they match the destination price zones) and to verify the various postal services (tracked, registered, recorded-delivery) borne by the mailpieces. Depending on their sizes and configurations, said databases may or may not be integrated directly into the franking system.

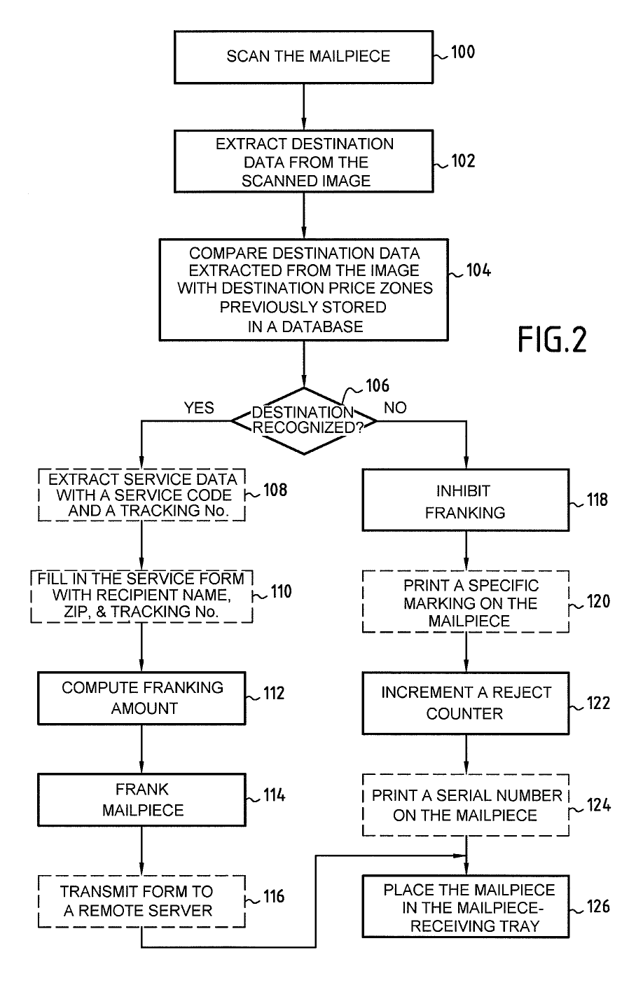

The method implemented in the above-described franking machine is shown in the flow chart of FIG. 2.

With the mailpieces being placed in mixed manner in batches (each batch corresponding to a given class of mail) in the feed module 12, and with a first mailpiece being extracted from said module, firstly, in the optical read module 22, in a first step 100, the mailpiece is scanned so as to obtain an image 30 of the front (upper face of the mailpiece), then, in a step 102, OCR software is used to extract from said image an item of destination data present in the destination address and making it possible to determine the destination price zone of the destination address. Said destination data (post code or ZIP code) extracted from the image of the destination address is then, in a step 104, compared with destination price zones stored previously in a data base 22 so as to determine whether said destination data extracted from the image of the mailpiece belongs to any of the price zones stored in the database. If the printed destination data is recognized (answer “yes” to the test of step 106), it is possible, in a step 108, to extract the service data that is optionally present on the mailpiece from the initial image, so as to determine for said service data the characteristic code of the service in question, and to extract the following numerals so as to determine a tracking number associated with the recognized service code. Then, in a step 110, a form relating to the recognized service is automatically filled in with the name of the recipient, the post code or ZIP code, and the tracking number before the franking amount is computed automatically (it being possible for the mailpiece that arrived in the franking module 18 to have, in the meantime, been weighed by the dynamic weigh module 16 when that module is present) in a step 112, prior to placing the postal imprint on the mailpiece, in a step 114, itself preceding a possible final step 116 performed if an item of service data has been previously recognized and consisting in transmitting the previously filled-in form to the remote server of the dealer of the franking system or of the postal authority for subsequent use when delivering the mailpiece. Conversely, if it has not been possible to recognize the item of destination data (answer “no” to the test 106) either because it had illegible or incomplete characters (or it requires processing that is too long and that cannot be finalized within the allotted time in view of the speed of conveying of the mailpiece), or because it does not correspond to the destination address indicated, then, in a step 118, printing the postal imprint is inhibited as the mailpiece goes past the franking means, thereby preventing any franking of the mailpiece and, instead, a specific marking is printed on the mailpiece, in step 120, unless a serial number has been printed on each of the mailpieces in a step 124 before said mailpiece is directed, in a final step 126, towards the mailpiece-receiving tray 20 or towards a reject additional tray (step not shown) when the machine has such a reject tray. Previously, in a step 122, a reject counter 28 totaling the number of rejects and distinguishing between the possible reasons for rejection is incremented so as to enable the operator, once the batch of mail has been processed, to know, by it being displayed on the screen 18B, the number of rejected mailpieces present in the mailpiece-receiving tray 20 depending on the reason for rejection. Thus, with a counter that can distinguish between the three main reasons for rejection (processing incomplete, characters illegible or incomplete, and recipient unknown at the address indicated or address inexistent), the operator can anticipate processing of these rejected mailpieces, as indicated in more detail below.

In any event, the process of conveying the mailpieces through the franking system is never interrupted, and the rate of processing of the mailpieces can thus be maintained at its highest level.

The specific marking associated only with those mailpieces for which it has not been possible to recognize the destination data can consist in a 2-dimensional (2D) bar code or in an identification number printed successively on each of the mailpieces, e.g. in the immediate vicinity of the destination address (the numeral 13 in FIG. 1) or of the postal imprint zone. The specific marking makes it possible for these mailpieces that have not been franked during the first stage of processing to be processed manually and subsequently by video coding.

Those mailpieces for which it has not been possible to recognize the destination data are, in a second stage, subjected to additional processing so as to attribute a valid destination price zone to each of them or so as to return them to their senders (in practice, the department or the person in the sender firm who sent the mailpiece, optionally after it has been opened by the mail department).

This attribution of a new destination price zone is performed directly at the user interface 18A of the franking module where the images 30 of the destination addresses of the mailpieces corresponding to the non-recognized destination data can be displayed one after another in the order in which they were rejected or in any order on the basis of their identification numbers (when such numbers exist), and be corrected manually by the operator, if necessary using appropriate correction tools that make use of the above-mentioned database or of any other database such as a phonebook or a telephone directory, or indeed a business directory. Once the destination data has been corrected (shown by reference 32 in FIG. 1), the correct franking amount can then be computed automatically, and the postal imprint printed immediately on the mailpiece.

It should be noted, however, that when absence of printing has resulted from a lack of time, with the computation time having exceeded the allotted time for conveying the mailpiece from the optical read module 22 to the franking module 18, this manual correction step is not necessary, because since that computation has nevertheless been completed after the first pass of the mailpiece, the franking amount is available, and, since it is associated with a specific marking, makes it possible automatically (without any other inputting) to frank the corresponding mailpiece during the second pass for processing the non-previously-franked mailpieces. In this respect, the advantage of a reject counter should be noted. Such a reject counter enables the operator to decide whether, during the second stage of processing, the rejected mailpieces should merely be passed through the system again (computation ended after printing), or whether operation using the video coding mode via the interface 18A should be considered (when the address is illegible or inexistent).

It should also be noted that the use of specific marking makes it possible, during the additional processing of the mailpieces for which it has not been possible to recognize the destination data during initial processing of them, to associate printing of the mailpiece bearing an incorrect address with printing of a label with a corrected new address. During the second stage of the processing, scanning the specific marking, bar code, or identification number of each of the non-franked mailpieces makes it possible to associate a new address with the mailpiece whose address is incorrect (the post code being, for example, incompatible with the indicated city), and to frank said mailpiece before directing it to the mailpiece-receiving tray 20 and then immediately to print the label bearing said new address, which label is in turn directed to the mailpiece-receiving tray and thus finds itself immediately above the mailpiece bearing the incorrect address to be corrected. Thus, after said second stage of processing, each of the mailpieces present in the mailpiece-receiving tray 20 is franked and, in addition, covered with a label bearing the corrected address, and it merely remains for the operator to stick each of the labels on the associated mailpieces (i.e. to stick each label on the mailpiece immediately below it) in order to form a new stack of mailpieces ready for delivery.

It should also be noted that although consideration is given above to printing a specific marking on each of the non-franked envelopes only, it is also possible to print serial identification numbers on all of the mailpieces to be franked. In this way, when a reject tray is not provided, it is possible to use dichotomic search to facilitate extracting non-franked mailpieces from all of the mailpieces, the non-franked mailpieces being identified by their respective numbers on the user interface of the franking machine.

What is claimed is:

1. A method of searching for a destination price zone applicable to a mailpiece fed into a franking machine of the closed type having means for franking it with a postal imprint, and ejected towards a mailpiece-receiving tray once it is franked, wherein, for each of said mailpieces, said method comprises the following steps:
scanning said mailpiece so as to obtain an image of at least a destination address printed on said mailpiece;
extracting an item of destination data from said image by means of an optical character recognition unit;
comparing said destination data extracted from said image of the destination address of said mailpiece with destination price zones previously stored in a database so as to determine whether said extracted destination data belongs to any of said destination price zones stored in said database;
if it cannot be established that said extracted destination data belongs to any of said destination price zones stored in said database before the mailpiece goes past said franking means, incrementing a counter totaling a number of non-franked mailpieces that is associated with at least one determined reason for non-franking; and
ejecting said mailpiece, without printing said postal imprint, and without stopping conveying of the following mailpieces through said closed-type franking machine.

2. A method according to claim 1, further comprising a step of printing a specific marking on each of said mailpieces for which it has not been possible to find said destination data in said database.

3. A method according to claim 2, wherein said specific marking comprises a bar code or an identification number.

4. A method according to claim 1, further comprising a step of printing a serial number on each of said mailpieces.

5. A method according to claim 1, wherein said at least one determined reason for non-franking is at least one of the following reasons: processing incomplete, characters illegible or incomplete, recipient unknown at the address indicated, or address inexistent.

6. A method according to claim 1, wherein said non-franked mailpieces are directed towards a reject tray.

7. A method according to claim 1, further comprising a step of reloading said non-franked mailpieces followed by a step of manually searching for a valid destination price zone on the user interface of said franking machine of the closed type.

8. A method according to claim 1, further comprising a step of extracting an item of service data from said image by means of said optical character recognition unit so as to determine a characteristic code of the service in question, and an associated tracking number, if it can be established that said extracted destination data belongs to at least one of said destination price zones stored in said database.

9. A method according to claim 8, further comprising a step of automatically filling in a form relating to the recognized service with a recipient name, a post code, and said tracking number.

10. A method according to claim 8, further comprising a step of transmitting said form to a remote server (26).

11. A franking machine of the closed type making it possible to search for the destination price zone that is applicable to a mailpiece fed into said machine and ejected towards a mailpiece-receiving tray once it is franked, wherein said franking machine includes:
means for scanning said mailpiece and for obtaining an image of at least a destination address printed on said mailpiece;
means for extracting an item of destination data from said image by means of an optical character recognition unit;
means for comparing said destination data extracted from said image of the destination address of said mailpiece with destination price zones previously stored in a database, and for determining whether said extracted destination data belongs to any of said destination price zones stored in said database;
means for preventing printing of a postal imprint while the mailpiece is going past franking means of said franking machine of the closed type if it cannot be established that said extracted destination data belongs to any of said destination price zones stored in said database before the mailpiece goes past said franking means; and
means for incrementing a counter totaling a number of non-franked mailpieces that is associated with at least one determined reason for non-franking.

12. A machine according to claim 11, further including means for printing a specific marking on each of said mailpieces for which it has not been possible to find said destination data in said database.

13. A machine according to claim 11, further including means for printing a serial number on each of said mailpieces.

14. A machine according to claim 11, wherein said specific marking comprises a bar code or an identification number.

15. A machine according to claim 11, further including a reject tray towards which said non-franked mailpieces are directed.
